(19) United States
(12) Patent Application Publication
(10) Pub. No.: US 2011/0232038 A1
(43) Pub. Date: Sep. 29, 2011

(54) HAND GRIP

(76) Inventor: Brian Thomas James Miller, Macclesfield (GB)

(21) Appl. No.: 13/069,201

(22) Filed: Mar. 22, 2011

(30) Foreign Application Priority Data
Mar. 25, 2010 (GB) GB1005101.9
Dec. 22, 2010 (GB) GB1021939.2

(51) Int. Cl. B25G 1/10

(52) U.S. Cl. 16/421

(57) ABSTRACT

A hand grip for the handle or shaft of a device is disclosed. The hand grip provides a waterproof, comfortable and optionally heated hand grip for a user. The hand grips find use, for example, on or around handles of sporting equipment and accessories, garden tools, wheelchairs, umbrellas, prams and pushchairs; and on or around the shaft of an umbrella.

### FIELD OF THE INVENTION

The present invention relates to a hand grip for the handle or shaft of a device, particularly a hand grip that provides a waterproof, comfortable and optionally heated hand grip for the user. Such hand grips find use, for example, on or around handles of sporting equipment and accessories, garden tools, wheelchairs, umbrellas, prams and pushchairs; and on or around the shaft of an umbrella.

### BACKGROUND TO THE INVENTION

Hand grips for devices such as sporting equipment and accessories, tools, etc. are known and generally are fabricated from resilient or flexible materials such as moulded plastics and may be wrapped in leather or towelling. Such hand grips generally are not waterproof, comfortable or warm, nor are they conveniently retrofitted, easily removed for washing, drying or replacing, nor can they be heated.

Examples of hand grips are described variously in U.S. Pat. No. 6,998,576, U.S. Pat. No. 5,834,734, U.S. Pat. No. 4,937,429 and U.S. Pat. No. 4,471,209.

### STATEMENTS OF INVENTION

The present invention aims to overcome one or more of the above disadvantages by providing a waterproof, comfortable, optionally heated hand grip for a handle or shaft of a device that can be conveniently retrofitted to handles or shafts of devices such as sporting equipment and accessories, garden tools, wheelchairs, umbrellas, prams and pushchairs. In addition, the present invention aims to provide a hand grip that can reduce vibration normally transmitted through the handle or shaft.

According to the present invention there is provided a hand grip for a handle or a shaft of a device comprising:

one or more layers of a sheet material that can be formed on or around the handle or the shaft; and

a means of fixing the hand grip to secure it to or secure it around the handle or shaft.

The device may be any device with a handle or shaft that is gripped by a user including for example a golf trolley, umbrella, garden spade, garden trowel, pram and pushchair.

In one embodiment the hand grip of the present invention is particularly suitable for use in devices having closed loop handles.

In a further embodiment of the present invention the hand grip is particularly suitable for use on or around the shaft of a device, especially on the shaft of an umbrella.

The sheet material may be any material that is flexible enough to form the hand grip on or around the handle or shaft; preferably the sheet material has the ability to stretch in multiple directions.

The sheet material may be selected from synthetic rubber, natural rubber, sheet polymeric foam and polyurethane; particularly from bromobutyl, chlorobutyl, butyl, chloroprene (such as neoprene) and silicone rubbers. Preferred sheet materials are those which have elasticity sufficient to form a close fitting hand grip which may mould to the shape of the handle or shaft.

An especially preferred sheet material is neoprene.

The sheet material can be formed on or around the handle or shaft; where the phrase ‘can be formed on’ is used this means that the sheet material may be applied directly to the handle or shaft of the device but does not necessarily form a sleeve around the handle or shaft; and where the phrase ‘can be formed around’ is used this means that the sheet material forms a sleeve around the handle or shaft of the device.

The means of fixing the sheet material to the handle or shaft may be anything that can be conveniently used including means of fixing directly to the handle or shaft and means of fixing the sheet material to itself to form a sleeve that fits around the handle or shaft.

Where the phrase ‘secured to’ is used this means that the sheet material is secured directly to the handle or shaft of the device. Suitable means of securing the hand grip directly to the handle or shaft include for example adhesive, adhesive tape and Velcro (Velcro is a trade mark of Velcro Industries B.V.). Where Velcro is used this may be conveniently attached to the sheet material using an adhesive or by stitching.

Where the phrase ‘secured around’ is used this means that the sheet material is secured to itself to form a sleeve around the handle or shaft of the device. Suitable means of securing the sheet material to itself include an open ended zip fastener, Velcro, adhesive (applied along the edge of the sheet material) and stitching. Where Velcro or a zip fastener is used this may be conveniently attached to the sheet material using an adhesive or by stitching.

The sheet material may comprise one or more layers. Where more than one layer of sheet material is used the separate layers of sheet material may be fixed to each other over their whole surfaces or over part of their surfaces or they may be fixed to each other by attaching one or more of the edges of each layer of the sheet materials together. Suitable means of fixing separate layers of sheet material include any of those described above for securing the sheet material on or around the handle or shaft.

Where more than two or more layers of sheet material are present in the hand grip the sheet materials may be the same or different. Where two or more layers of sheet material are present they are preferably the same, and more preferably the two or more layers are neoprene.

In one embodiment of the present invention the hand grip further comprises a heating element formed into a circuit for heating the hand grip. The heating element may be any convenient means for delivering heat to the hand grip. Suitable materials for the heating elements include heat and/or electrically conductive materials such as metals and conductive polymers, preferably metals such as copper and nickel.

The heat and/or electrically conductive material may be in the form of single or multi-stranded wires, sheets or in flattened strips, or may be formed into a printed circuit comprising a heating element in a plastics material, ideally a flexible plastics material, preferably a heat resistant plastics material, especially a polyimide.

The heating element may be heated by passing an electric current through it, the electric current may be conveniently supplied by one or more batteries connected in series, the batteries may be rechargeable batteries. Where batteries are used to supply the electric current these may be conveniently located in a battery holder fitted with appropriate connectors. Appropriate connectors include for example a jack plug and socket, screw connectors, butt connectors, terminal block connectors or push fit connectors. The battery holder may be fabricated from any suitable material such as a plastics material. The battery holder may be attached to the device by any suitable means such as Velcro, adhesive, adhesive tape, clips of suitable size and shape; alternatively the battery holder could be formed as an integral part of the device, for example, formed into the handle of the device.

The circuit comprising the heating element and the batteries optionally further comprises an on-off switch; optionally further comprises an indicator light to indicate when the circuit is switched on and optionally further comprises a means of regulating the current delivered to the heating element.

Where the hand grip comprises a heating element this may be combined with one or more layers of sheet material. Where only one sheet material is used the heating element is located between the sheet material and the handle or shaft of the device. Where two or more sheet materials are used the heating element may be sandwiched between separate layers of sheet material, ideally beneath the outer layer of sheet material closest to the user's hand.

The heating element may be fixed to the sheet material or may be held in place because the sheet material fits closely to the handle or shaft of the device. Where the heating element is fixed to the sheet material this may be by any convenient means for example by adhesive or adhesive tape. Where the heating element is sandwiched between two layers of sheet material it may be fixed to one or both of the layers; or it may be retained in place by the two layers of sheet material being fixed to each other along one or more of their edges but in this instance the layers of sheet material are not fixed to the heating element.

An optional heat reflector, such as aluminium foil, may be located between the heating element and the handle or shaft of the device. An optional heat insulator, such as polymer foam or neoprene may be located between the heating element and the handle or shaft of the device.

The hand grips may be fabricated in any size suitable to form a close fit to the handle or shaft of the device.

In a first preferred embodiment of the present invention the hand grip comprises one or more layers of sheet material where the fixing means is an opened ended zip fastener and one side of the zip fastener is attached to one edge of the sheet material and the other side of the zip fastener is attached to an opposite edge of the sheet material such that the zip fastener may be fastened to form a sleeve of sheet material around the handle or shaft of the device.

In a second preferred embodiment of the present invention the hand grip comprises at least two layers of sheet material.

In a third preferred embodiment of the present invention where the hand grip comprises at least two layers of sheet material the hand grip further comprises a heating element.

### BRIEF DESCRIPTION OF THE DRAWINGS

The invention will be more fully described and understood by reference to the following description and drawings in which:

FIG. 1 illustrates a sheet material of a hand grip with a zip fastener as the fixing means shown at A in the open position, and shown at B in the closed position;

FIG. 2 illustrates a hand grip in place around an open handle;

FIG. 3 illustrates a sectional view through a hand grip showing a heating element between two layers of sheet material;

FIG. 4 illustrates a heating element;

FIG. 5 illustrates a hand grip in place around a closed handle showing in part section a battery holder attached to a handle;

FIG. 6 illustrates a hand grip in place around a closed handle showing a part sectional view of a heating element and in part section a battery holder attached to the handle;

FIG. 7 illustrates a hand grip in place around the shaft of a device.

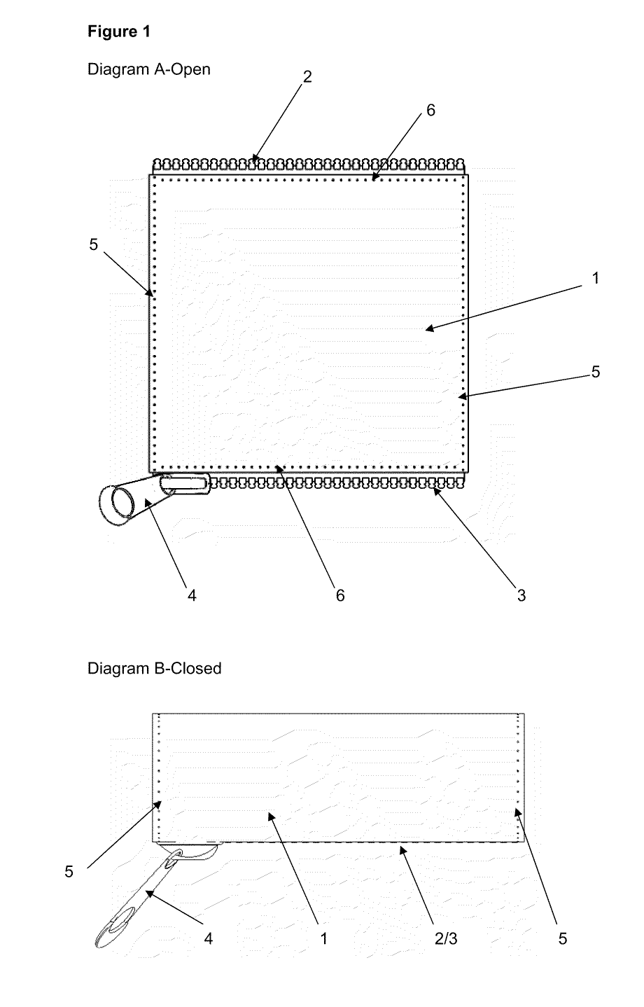

FIG. 1 illustrates a sheet material 1 of a hand grip with a zip fastener as the fixing means shown at A in the open position, and shown at B in the closed position.

In A the open zip fastener has two parts 2 and 3; these two parts are attached to sheet material 1 by stitching 6. The zip fastener has a zip pull 4. The edges of the sheet material 1 are finished off to prevent fraying and/or to attach two or more layers of sheet material together by stitching 5.

In B the zip fastener is shown closed with the two parts 2 and 3 of the zip fastener zipped together to form the sheet material 1 into a sleeve that fits around the handle of the device. The zip fastener has a zip pull 4. The edges of the sheet material 1 are finished off to prevent fraying and/or to attach two or more layers of sheet material together by stitching 5.

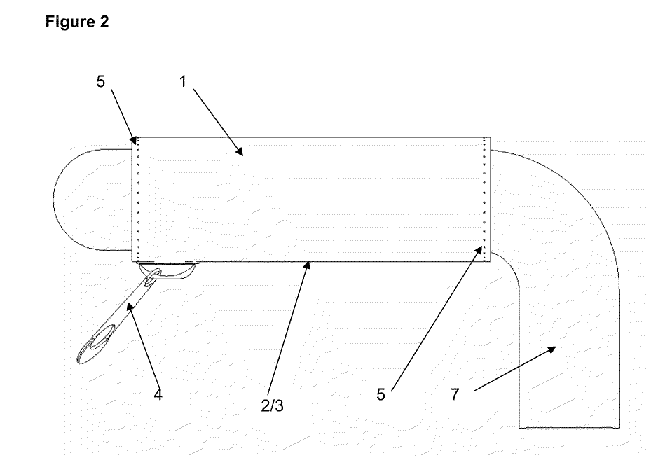

FIG. 2 illustrates a hand grip comprising a sheet material 1 formed into a sleeve by fastening the two parts 2 and 3 of the zip fastener zipped together around an open handle 7 of a device. The zip fastener has a zip pull 4. The edges of the sheet material 1 are finished off to prevent fraying and/or to attach two or more layers of sheet material together by stitching 5.

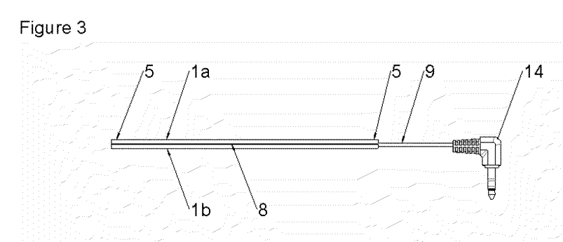

FIG. 3 illustrates a sectional view through a hand grip showing a heating element 8 positioned between two layers of sheet material 1a and 1b with wires 9 for attachment to an electric power source via a jack plug 14. The heating element 8 is not directly attached to either piece of sheet material 1a and 1b but is retained by the two layers of sheet material 1a and 1b being stitched together by stitching 5; the stitching 5 does not pass through the heating element 8.

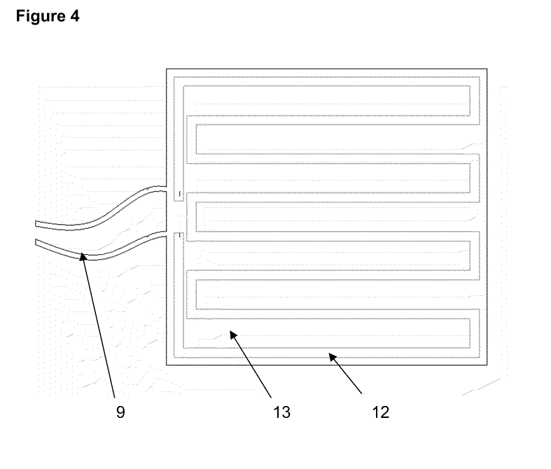

FIG. 4 illustrates a heating element which comprises a metal heat conductive material 12 in a polymer layer 13 with wires 9 for attachment to an electric power source.

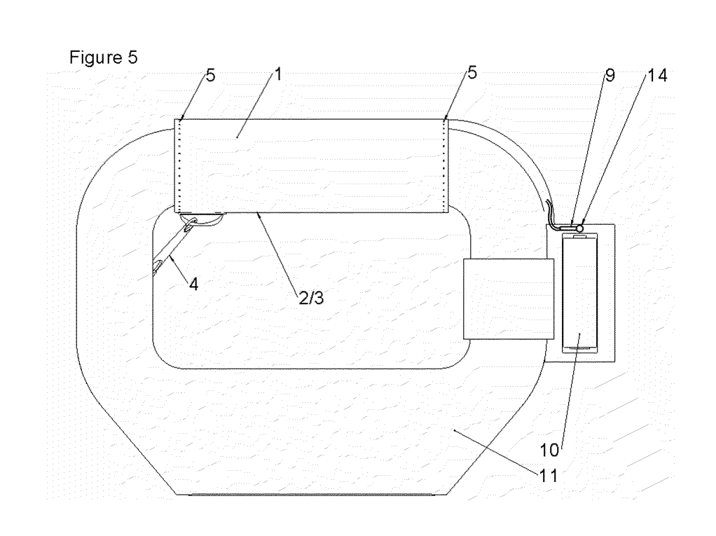

FIG. 5 illustrates a hand grip comprising a sheet material 1 formed into a sleeve by fastening the two parts 2 and 3 of the zip fastener together around a closed handle 11 of a device. Wires 9 (from the heating element) are attached to a battery 10 as power source via a jack plug 14. The zip fastener has a zip pull 4. The edges of the sheet material 1 are finished off to prevent fraying and/or to attach two or more layers of sheet material together by stitching 5.

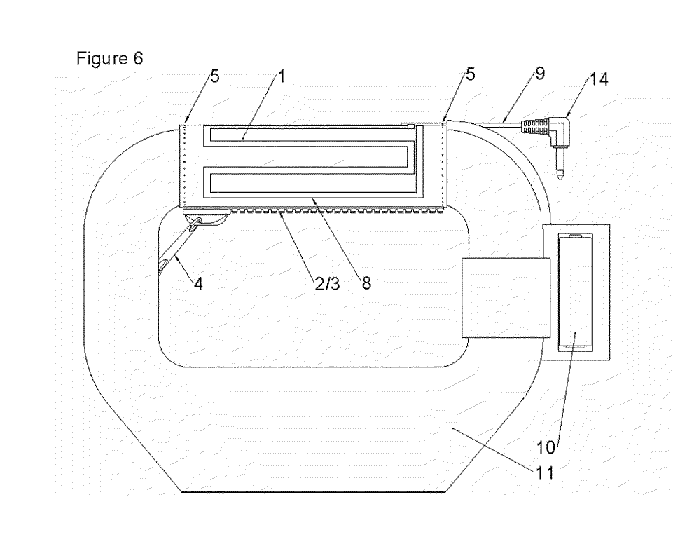

FIG. 6 illustrates a hand grip comprising a sheet material 1 formed into a sleeve by fastening the two parts 2 and 3 of the zip fastener together in place around a closed handle 11 of a device. The heating element 8 is shown in part sectional view inside the outer sheet material layer. Wires 9 (from the heating element 8) are attached to a battery 10 as power source via a jack plug 14. The zip fastener has a zip pull 4. The edges of the sheet material 1 are finished off to prevent fraying and/or to attach two or more layers of sheet material together by stitching 5.

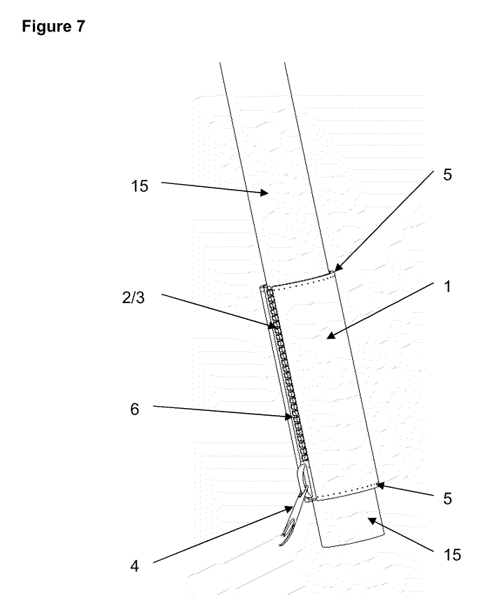

FIG. 7 illustrates a hand grip comprising a sheet material 1 formed into a sleeve by fastening the two parts 2 and 3 of the zip fastener zipped together around a shaft 15 of a device. The two parts 2 and 3 of the open zip fastener are attached to sheet material 1 by stitching 6. The zip fastener has a zip pull 4. The edges of the sheet material 1 are finished off to prevent fraying and/or to attach two or more layers of sheet material together by stitching 5.

1. A hand grip for a handle or shaft of a device comprising:
one or more layers of a sheet material that can be formed on or around the handle; and
a means of fixing the hand grip to secure it to or secure it around the handle.

2. A hand grip according to claim 1 in which the sheet material is selected from synthetic rubber, natural rubber, sheet polymeric foam and polyurethane.

3. A hand grip according to claim 1 in which the sheet material is selected from bromobutyl, chlorobutyl, butyl, chloroprene and silicone rubbers.

4. A hand grip according to claim 1 in which the sheet material is neoprene.

5. A hand grip according to claim 1 in which the hand grip comprises two layers of sheet material.

6. A hand grip according to claim 5 in which both layers of sheet material are neoprene.

7. A hand grip according to claim 1 in which the sheet material is secured directly to the handle of the device by an adhesive, adhesive tape or Velcro.

8. A hand grip according to claim 1 in which the sheet material is secured by an open ended zip fastener, Velcro, adhesive (applied along the edge of the sheet material) or stitching to form a sleeve around the handle of the device.

9. A hand grip according to claim 1 in which the sheet material is secured by an open ended zip fastener to form a sleeve around the handle of the device.

10. A hand grip according to claim 1 that further comprises a heating element.

11. A hand grip according to claim 10 that further comprises an optional heat reflector located between the heating element and the handle of the device.

12. A hand grip according to claim 10 in which the heating element comprises a metal in a flexible plastics material.

13. A hand grip according to claim 1 for the handle of a device.

14. A hand grip according to claim 1 for the shaft of a device.

15. A hand grip according to claim 14 in which the device is an umbrella.
